(19) United States
(12) Patent Application Publication
(10) Pub. No.: US 2003/0087627 A1
(43) Pub. Date: May 8, 2003

(54) Wireless device temporary recovery mode services and functionality

(76) Inventor: Joseph M. Cannon, Harleysville, PA (US)

Correspondence Address: MANELLI DENISON & SELTER PLLC, 7th Floor, 2000 M Street, N.W., Washington, DC, 20036-3307, US

(21) Appl. No.: 09/985,352

(22) Filed: Nov. 2, 2001

(51) Int. Cl. H04M 11/00

(52) U.S. Cl. 455/404; 455/456

(57) ABSTRACT

A lost or stolen wireless device is restricted by the activation of a temporary recovery mode service by their service provider pursuant to a call from the subscriber on another phone. The temporary recovery mode service permits the user to select any one of a plurality of possible temporary recovery mode options. Preferably, the temporary recovery mode options limit or entirely restrict further expense incurred by the use of the wireless device until it is found and the recovery service is deactivated. Exemplary temporary recovery mode options include allowing the missing wireless device, e.g., to only receive calls, to allow local outgoing calls only, etc. Another temporary recovery mode option allows full functionality only until the monthly plan allotment of free minutes is used up, and then automatically disables use of the wireless device, or then automatically allows only calls to be received, only local calls to be made, only calls to certain telephone numbers to be made, etc.

### BACKGROUND OF THE INVENTION

1. Field of the Invention

This invention relates generally to wireless devices. More particularly, it relates to recovery of lost or stolen wireless devices, particularly wireless phones.

2. Background of Related Art

When a subscriber loses a wireless phone, or has it stolen, two opposing issues are confronted. First, the subscriber must decide whether or not they want their phone to remain activated allowing calls to be made. If they want their phone to remain activated, they would prefer that a potential finder of the phone return it to the subscriber. However, there is the risk that an activated phone will be misused, either intentionally by a thief, or unintentionally by a finder. In such a case, it might be preferred by the subscriber that the phone be deactivated to prevent the incurrence of expenses related to phone calls, particularly to long distance phone calls. Ordinarily, the second possibility outweighs the first, and the subscriber contacts their service provider to have their lost wireless phone deactivated.

One conventional way to protect a mobile phone or mobile wireless device from theft is to add a lock/unlock personal identification number (PIN) to lock and unlock the device. Using such a system, the device becomes disabled until a lock/unlock PIN is entered that matches a pre-stored lock/unlock PIN in memory of the mobile phone.

FIG. 10 illustrates a conventional mobile phone comprising an external antenna 1, an on/off button 2, a speaker 3, a cancel button 4, a menu selection button 5, scroll buttons 6 and 7, a numerical keypad 8, and a microphone 9.

In particular, as shown in FIG. 10, one conventional type mobile phone has a menu selection button 5 for access to a menu that will lock and unlock the device. Scroll buttons 6 and 7 allow a user to scroll through a menu system to choose a desired function. Once a lock and/or unlock menu is entered, the numerical keypad 8 is used to enter a lock/unlock PIN that the user will later use to both lock or unlock the device. The cancel button 4 may be depressed if the user mistakenly enters an incorrect lock/unlock PIN or wants to exit the current menu function.

FIG. 11 is a flow chart showing an exemplary process by which a lock/unlock PIN number is initially setup for use on a mobile phone.

In particular, as shown in FIG. 11, a software routine monitors keyboard entries to determine if a locking setup menu is chosen 10. If the locking setup menu 10 is not chosen, the software routine loops to continuously monitor if the user desires to enter the locking setup menu.

Once the user desires to enter the locking setup menu, a routine is called that requires a user to enter a lock/unlock PIN that will be used to lock or unlock the mobile wireless device 11.

A conventional method of assuring that a user enters the correct lock/unlock PIN is to have the user re-enter the lock/unlock PIN at routine 12. The lock/unlock PIN entered in routine 11 is compared with the lock/unlock PIN entered in routine 12. If the lock/unlock PIN entered in routine 11 is not the same as the lock/unlock PIN entered in routine 12, the program jumps back to routine 11 to force the user to begin the process over again to establish a lock/unlock PIN. If the lock/unlock PIN entered in routine 11 is the same as the lock/unlock PIN entered in routine 12, the program progresses to store the lock/unlock PIN 14.

The lock/unlock PIN is preferably stored in non-volatile memory. Non-volatile memory allows the lock/unlock PIN number to be maintained even without a constant source of power. The lock/unlock PIN would not be inadvertently erased if the battery power were allowed to run down, and a thief would not be able to erase the lock/unlock PIN by simply removing the battery pack.

FIG. 12 is a flow chart showing an exemplary process by which a lock/unlock PIN number is entered to lock or unlock a mobile phone.

In particular, as shown in FIG. 12, a software routine monitors if a lock and unlock menu is chosen 16. If the lock and unlock menu 16 is not chosen, the software routine loops to continuously monitor if user desires to enter the lock and unlock menu 16. Once the user enters the lock and unlock menu, a routine is called that requires a user to enter a lock/unlock PIN 17 that will be used to lock and unlock the mobile phone.

The entered lock/unlock PIN is compared to the lock/unlock PIN previously stored in memory 18 to determine if the proper lock/unlock PIN has been entered by the user. If the lock/unlock PIN entered by the user is not the same as the lock/unlock PIN stored in memory, the program branches back to the routine that requires the user to enter a lock/unlock PIN 17. If the lock/unlock PIN entered by the user is the same as the lock/unlock PIN stored in memory, the program continues on to determine the current state of the phone, either locked or unlocked 19. If a mobile phone is in a locked condition, a software routine unlocks the mobile phone to allow full functionality for the user at step 20. If the mobile phone is in an unlocked condition, the software routine locks the mobile phone 21. Once either the unlocking routine 20 or the locking routine 21 are completed, the lock/unlock menu function is exited at step 22.

Unfortunately, deactivation causes many disruptions and inconveniences to the subscriber, including lost phone calls and possibly the reassignment to a new phone number when ultimately found and reactivated.

Moreover, locking a mobile phone prevents further use, but does not assist a user in finding their mobile phone, nor does it deter a thief from hiding the phone on their person.

While use of a PIN to allow operation of a wireless device does discourage theft of a mobile phone, it does not assist a user in locating a merely lost phone. Moreover, PIN usage increases the complexity of normal operation of the phone even when not lost.

Thus, there is a need for a more convenient recovery mechanism particularly useful for wireless devices that are merely lost.

### SUMMARY OF THE INVENTION

In accordance with the principles of the present invention, a method of recovering a lost wireless device comprises activating a lost wireless device recovery mode relating to use of the lost wireless device, and restricting use of the lost wireless device while the lost wireless device recovery mode is active. The restricted use allows at least some use of the lost wireless device.

### BRIEF DESCRIPTION OF THE DRAWINGS

Features and advantages of the present invention will become apparent to those skilled in the art from the following description with reference to the drawings, in which:

FIG. 1 shows a recovery mode selector module together with a plurality of lost phone recovery modes, in accordance with the principles of the present invention.

FIG. 2 shows an exemplary process flow of the activation of the recovery mode selector module shown in FIG. 1.

FIG. 3 shows an exemplary process flow of the termination (e.g., after recovery of the lost phone) of the recovery mode selector module shown in FIG. 1.

FIG. 4 shows an exemplary process flow of a long distance disabler mode shown in FIG. 1.

FIG. 5 shows an exemplary process flow of a local calls only at designated times mode shown in FIG. 1.

FIG. 6 shows an exemplary process flow of an enable receive calls only mode shown in FIG. 1.

FIG. 7 shows an exemplary process flow of a local calls only until free minutes exhausted mode shown in FIG. 1.

FIG. 8 shows an exemplary process flow of a designated phone numbers only mode shown in FIG. 1.

FIG. 9 shows an exemplary display on an exemplary lost wireless device information relating that the lost wireless device is in fact lost.

FIG. 10 shows a conventional mobile phone with menu access buttons.

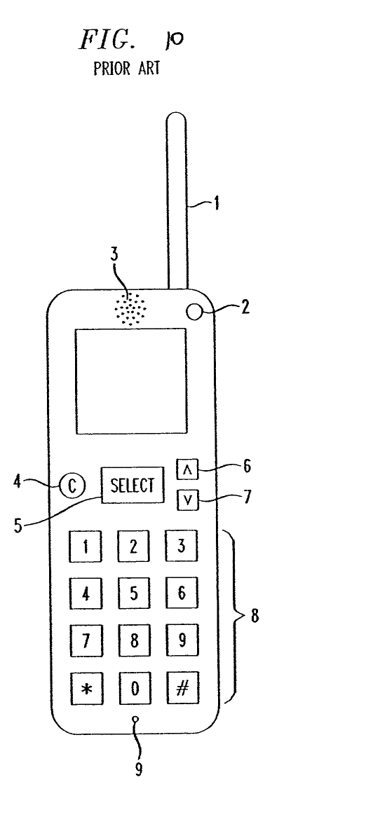

FIG. 11 shows a conventional flowchart of setting up a locking PIN number.

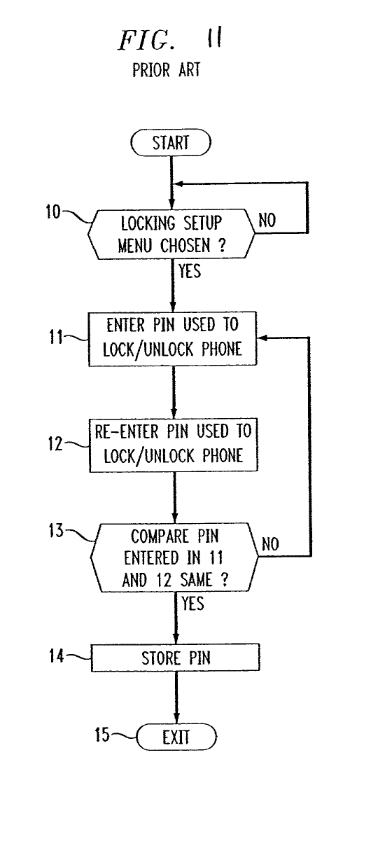

FIG. 12 shows a conventional flowchart of locking and unlocking the operation of a mobile phone.

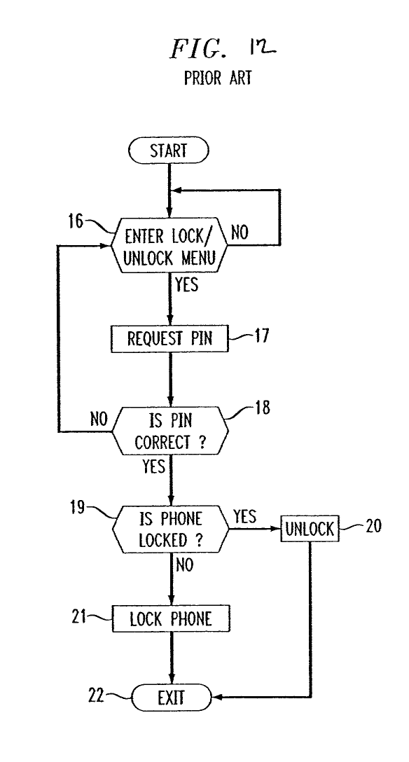

### DETAILED DESCRIPTION OF ILLUSTRATIVE EMBODIMENTS

The present invention offers wireless device users the opportunity to re-locate their lost wireless devices if not stolen, and/or the ability to deter a would-be thief, without permanently disrupting service to the rightful owner/operator of the wireless device.

In accordance with the principles of the present invention, the service provider of the wireless device may activate a temporary recovery mode in the wireless device, upon request from the rightful owner of the wireless device. The wireless device recovery mode importantly restricts use of the wireless device in a way which minimizes potential cost impact to the rightful owner of illicit use of the wireless device in the event that it might actually be stolen.

The temporary recovery mode services and functions in accordance with the principles of the present invention offer wireless device subscribers (e.g., wireless phone subscribers) the ability to find lost wireless phones (or other devices) without risk of incurred expense by unauthorized users, and without the inconveniences conventionally associated with the deactivation of the wireless phone.

In accordance with the principles of the present invention, when a subscriber fears that their wireless device has become lost or stolen, they are permitted to call their service provider, identify themselves as the authorized owner of the lost wireless device (e.g., by input of a PIN), and request that the service provider activate a recovery mode in the lost wireless device. The recovery mode may be activated by the rightful owner from, e.g., a different phone (landline or wireless), a web site, etc.

In the disclosed embodiments, the activated recovery mode may be one or more of a plurality of possible temporary recovery mode options. In any event, the temporary recovery mode options limit or entirely restrict further expense incurred by the use of the lost wireless device until it is found.

Restrictions imposed by the various recovery modes of the disclosed embodiments may be implemented either at the service provider, at the wireless device itself, or both. For instance, the wireless device may be programmed or otherwise instructed to no transmit call requests including long distance calls. Alternatively, the long distance calls may be prevented by the service provider after it receives a request for the establishment of a particular call. It is preferred that the lost wireless device recovery service be implemented in the service provider's facility, e.g., to minimize or eliminate the need for expense and logistical difficulties in providing wireless devices which implement lost phone recovery features such as those shown and described herein.

Once the lost wireless device is found, the owner may again contact their service provider, properly identify themselves as the rightful owner, and request that the temporary recovery mode be deactivated for the relevant wireless device.

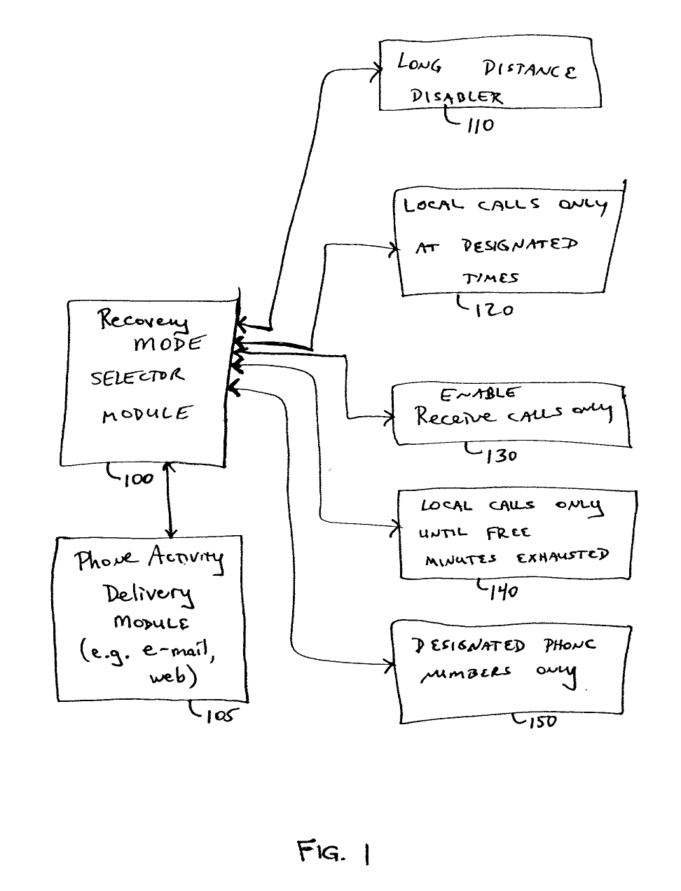

FIG. 1 shows a recovery mode selector module together with a plurality of lost phone recovery modes, in accordance with the principles of the present invention.

In particular, as shown in FIG. 1, a recovery mode selector module 100 may be implemented in an appropriate application platform in the service provider's network.

Exemplary temporary recovery mode options include allowing the missing wireless device, e.g., to only receive calls, to allow local outgoing calls only, etc.

Another temporary recovery mode option allows full functionality only until the monthly plan allotment of free minutes is used up, and then automatically disables use of the wireless device, or then automatically allows only calls to be received, only local calls to be made, only calls to certain telephone numbers to be made, etc.

In particular, the recovery mode selector module 100 is responsible for implementing, upon request by the authorized owner of a particular subscriber, restrictions upon expense incurring use of their wireless device.

For instance, in the disclosed embodiment shown in FIG. 1, the recovery mode selector module 100 may implement a restriction of long distance calls from the wireless device by initiating a long distance disabler 110. For instance, the long distance disabler mode 110 may impose the restriction that no long distance phone calls will be permitted from the relevant wireless device (i.e., local calls only). For these purposes, long distance may be determined locally in a broad sense, e.g., based on roaming, on the area code of the attempted dialed number, a country code, etc.

Alternatively (or additionally) a local calls only at designated times module 120 may be initiated. The designated times may be set by the owner (e.g., during nighttime hours only), or may be inferred by the owner by selection of a particular qualifier, e.g., only when reduced rates are in effect.

The wireless device may be authorized to receive calls only 130, such that all outgoing calls from the wireless device are denied service by the service provider (and roaming is preferably unauthorized).

Additional recovery modes which may be selected by the authorized owner may include, e.g., local calls only until previously allotted free minutes are exhausted 140. This mode may be extended to include use only until all prepaid minutes are used up. Thereafter, use of the wireless device may be entirely restricted.

As yet another exemplary mode, calls from the lost wireless device may be permitted only to designated phone numbers 150 (e.g., home or work phone numbers). The designated phone numbers may be maintained in a database or table, and set by the rightful owner via an appropriate user interface with their service provider.

Once the lost wireless device recovery mode is implemented, some or all wireless device activity information (e.g., call information) can be automatically and periodically delivered to the owner via a designated method, e.g., via an e-mail to a designated e-mail address for the owner, via a web option, via a periodic written summary, etc. In this way, the owner can see not only the extent to which their stolen wireless device is being used, but can also be aided in finding their lost wireless device. For instance, the owner might be able to infer who is using their phone (e.g., their husband, child, parent, etc.) by their knowledge of phone numbers having calls with the lost wireless device.

The service provider may occasionally or periodically request new recovery activation from the rightful owner of the lost wireless device, e.g., after free or prepaid minutes are exhausted. In an exemplary implementation, the new lost wireless device recovery activation request could be automatically generated and transmitted to the rightful owner who does not have their wireless device, e.g., via an e-mail to a designated e-mail address, via a status or similar information on a web page, etc.

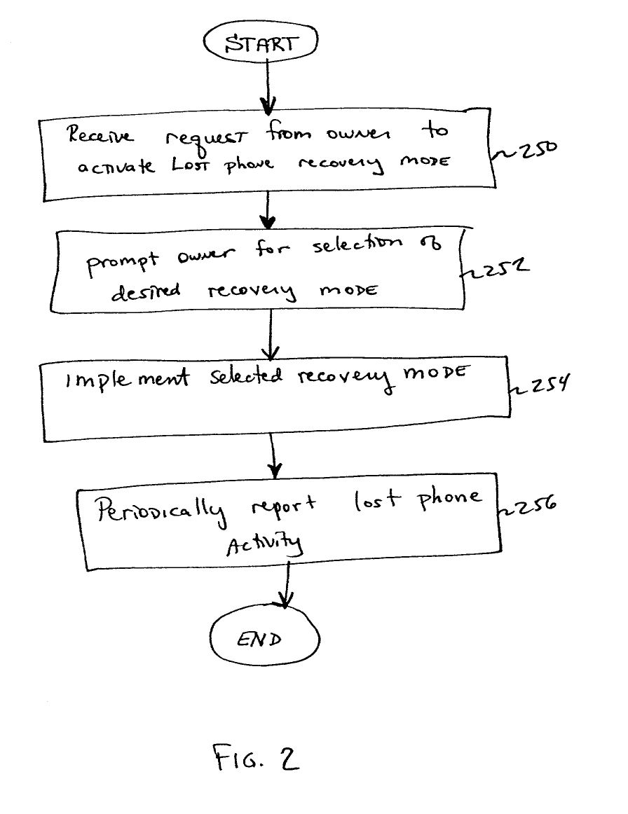

FIG. 2 shows an exemplary process flow of the activation of the recovery mode selector module shown in FIG. 1.

In particular, as shown in step 250 of FIG. 2, the recovery mode selector module 100 in the service provider's wireless network receives a request from the rightful owner of the wireless device to activate the lost phone recovery mode.

In step 252, the rightful owner of the lost wireless device is prompted for selection of a desired recovery mode.

In step 254, the selected recovery mode is implemented.

In optional step 256, an activity report for the lost wireless device may be occasionally or periodically reported. Alternatively, the lost wireless device activity report may be transmitted or presented to the rightful owner upon request (e.g., via the owner's access to an appropriate web page).

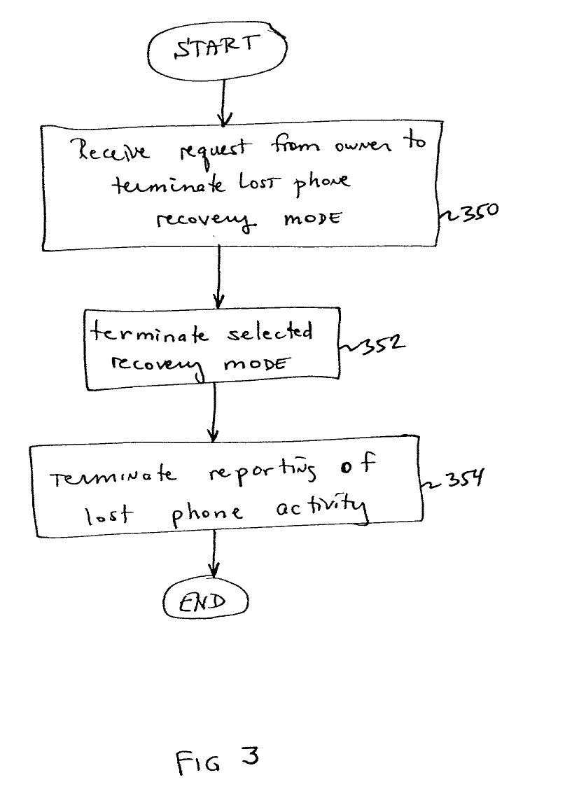

FIG. 3 shows an exemplary process flow of the termination (e.g., after recovery of the lost phone) of the recovery mode selector module shown in FIG. 1.

In particular, as shown in step 350 of FIG. 3, a request is received from the rightful owner of the lost wireless device to terminate any particular lost phone recovery mode that was previously activated.

In step 352, the selected recovery mode is terminated.

In step 354, the optional activity report relating to the lost wireless device may be terminated.

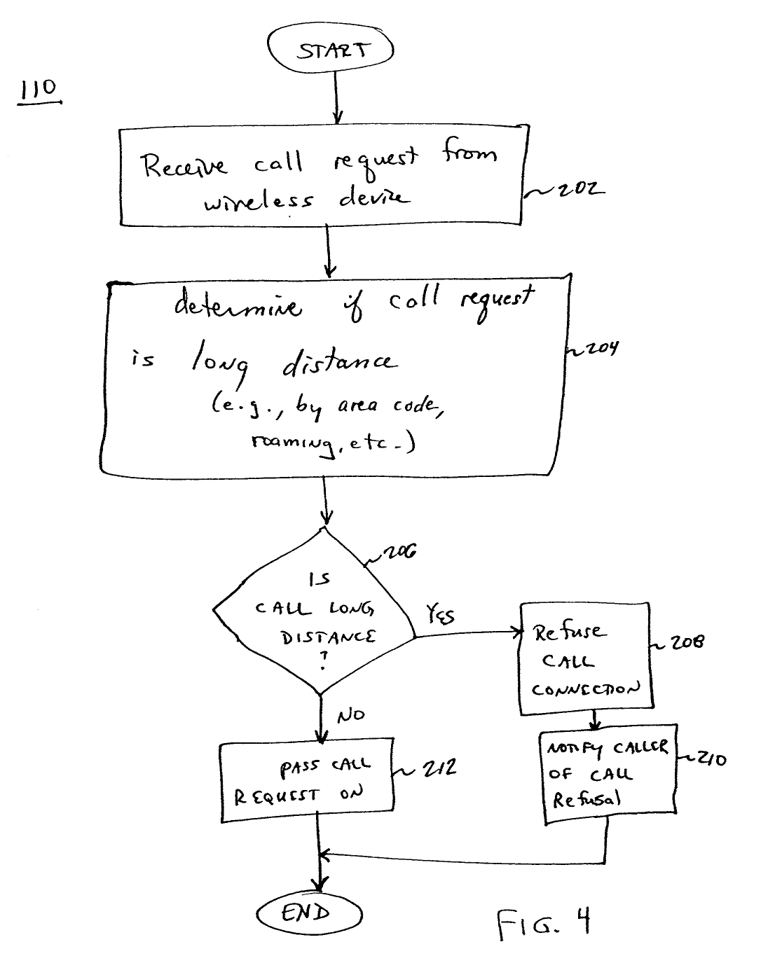

FIG. 4 shows an exemplary process flow of a long distance disabler mode shown in FIG. 1.

In particular, as shown in step 202 of FIG. 4, a call request is received by the service provider, and passed through the recovery mode selector module 100 for authorization to continue otherwise conventional call routing.

In step 204, the recovery mode selector module 100 determines whether or not the call request constitutes long distance which would incur call charges to the rightful owner. The determination is preferably determined locally (e.g., based on a review of the area code, the need to roam, etc.)

In step 206, if the call is long distance, the process proceeds to step 208, where the call request is refused by the service provider, and in step 210 the caller is notified of the refusal.

However, if the call is not long distance, the call request is passed on in step 212.

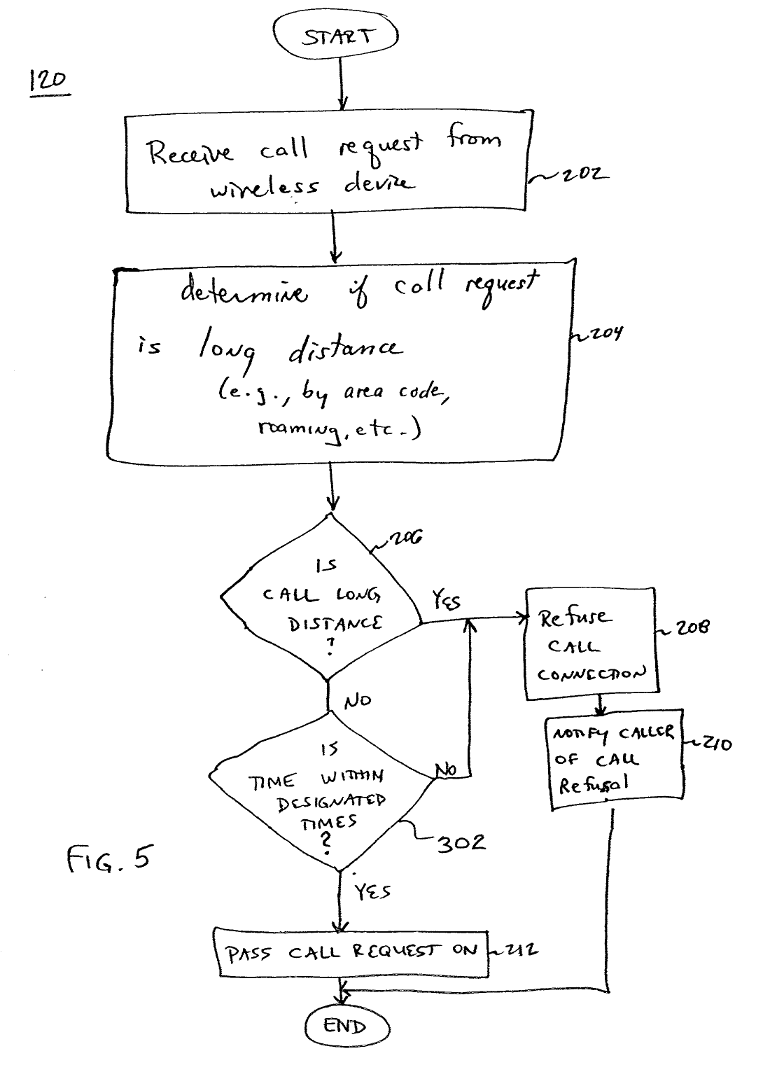

FIG. 5 shows an exemplary process flow of a local calls only at designated times mode shown in FIG. 1.

In particular, as shown in FIG. 5, the flow of FIG. 4, is implemented with the addition of a step 302 wherein the time of the call is checked against designated times to determine whether or not the call should be permitted.

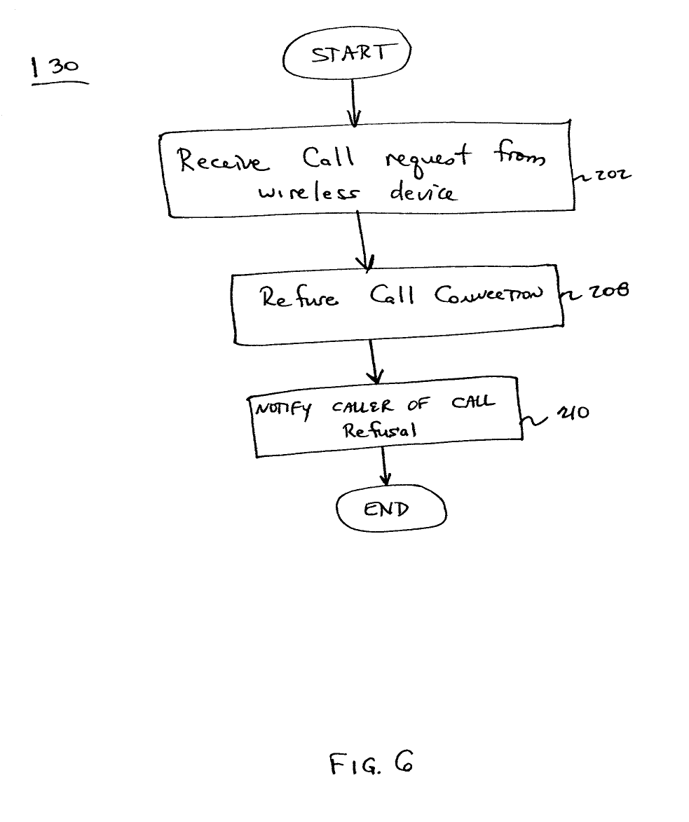

FIG. 6 shows an exemplary process flow of an enable receive calls only mode shown in FIG. 1.

In particular, as shown in FIG. 6, the process flow of FIG. 4 is greatly simplified to allow only incoming calls to proceed to the wireless device: no outgoing calls are permitted. Thus, when a call request is received from the lost wireless device in step 202, the call connection is simply refused in step 208 by the recovery mode selector module 100 in the service provider's network. Preferably, the user of the lost wireless device (and optionally the rightful owner via an alternative mechanism such as e-mail) is notified of the refusal of the attempted outgoing call in step 210.

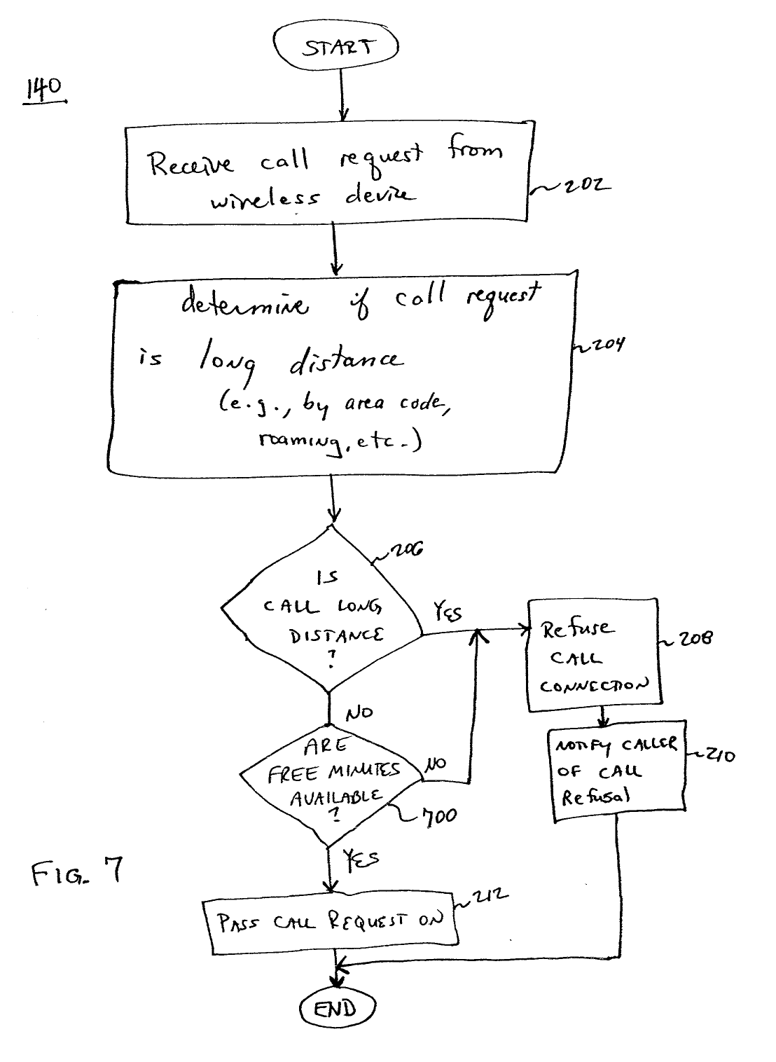

FIG. 7 shows an exemplary process flow of a local calls only until free minutes exhausted mode shown in FIG. 1.

In particular, as shown in FIG. 7, the flow of FIG. 4, is implemented with the addition of a step 700 wherein the availability of free minutes is determined before allowing the call request to be passed on by the service provider.

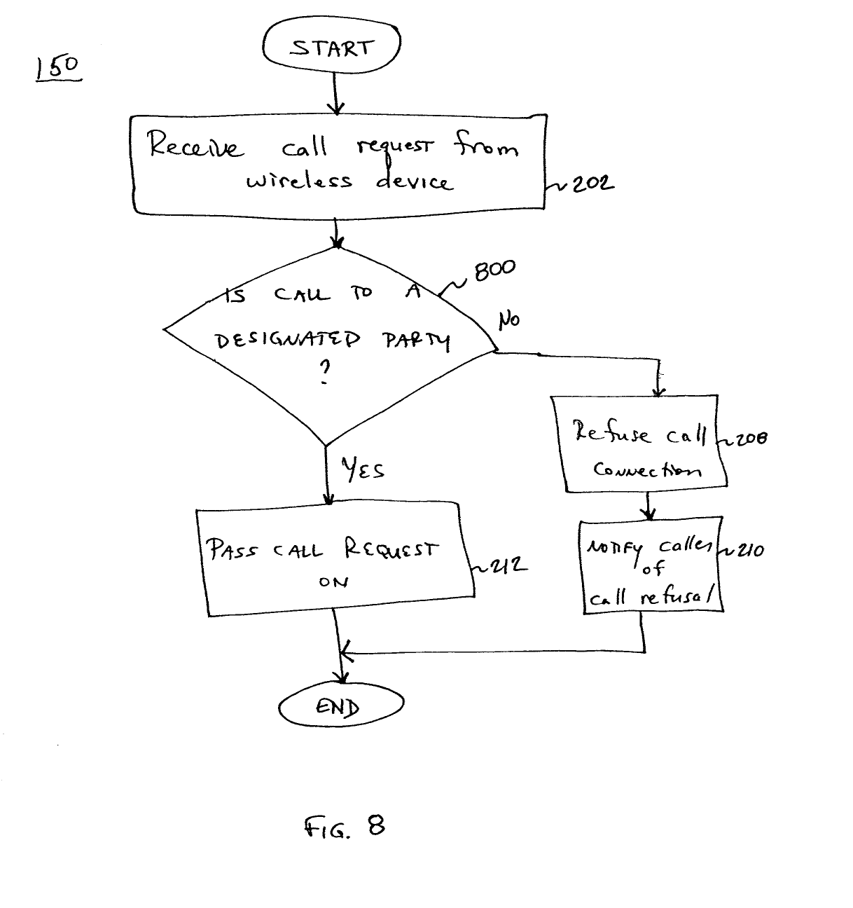

FIG. 8 shows an exemplary process flow of a designated phone numbers only mode shown in FIG. 1. In particular, as shown in FIG. 8, the process flow of FIG. 4 is again simplified to allow outgoing calls (and optionally also incoming calls) only with designated parties, as depicted in step 800. The designated parties may be input into an appropriate database or table maintained by the recovery mode selector module 100 by the rightful owner either before or even after the wireless device is lost via, e.g., a web page, another phone, etc.

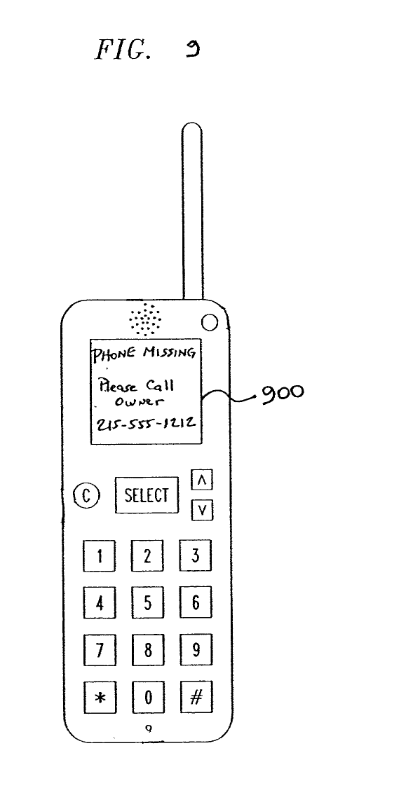

FIG. 9 shows an exemplary display on an exemplary lost wireless device information relating that the lost wireless device is in fact lost.

In particular, as shown in FIG. 9, an appropriate message may be displayed on the lost wireless device aiding any finder in locating the rightful owner. For instance, the display of a wireless phone as shown in FIG. 9 may indicate, e.g., “PHONE MISSING-Please Call Owner: 215-555-1212.” The message may be global in design, e.g., “Call Service Provider's lost and found at 202-555-1234”, or may be customized by the owner, e.g., via a web page.

Moreover, the particularly displayed message may be changed based on the particular time of day. For instance, the wireless device presumably has access to real-time clock information, allowing display of, e.g., a home number to be called during nighttime hours, and a All work number to be called during work hours Monday-Friday.

While the embodiments of the present invention are shown with respect to a wireless phone (e.g., a cell phone), the principles of the present invention have equal applicability to other types of lost or stolen wireless devices, e.g., wireless Personal Digital Assistant (PDA) devices, pagers, laptops, etc.

In accordance with the principles of the present invention, a wireless device user (particularly a wireless phone user) will enjoy increased odds of having their lost or stolen phone back with features which may be activated either by an owner or by a service provider. It provides for increased flexibility in the recovery of popular devices.

While the invention has been described with reference to the exemplary embodiments thereof, those skilled in the art will be able to make various modifications to the described embodiments of the invention without departing from the true spirit and scope of the invention.

What is claimed is:

1. A method of recovering a lost wireless device, comprising:
activating a lost wireless device recovery mode relating to use of said lost wireless device; and
restricting use of said lost wireless device while said lost wireless device recovery mode is active, said restricted use allowing at least some use of said lost wireless device.

2. The method of recovering a lost wireless device according to claim 1, further comprising:
transmitting for display on said lost wireless device information relating that said lost wireless device is in fact lost.

3. The method of recovering a lost wireless device according to claim 1, wherein:
said lost wireless device recovery mode is activated at a service provider providing service to said lost wireless device.

4. The method of recovering a lost wireless device according to claim 1, wherein:
said activating is performed via a web page.

5. The method of recovering a lost wireless device according to claim 1, wherein:
said activating is performed via a phone other than said lost wireless device.

6. The method of recovering a lost wireless device according to claim 1, further comprising:
reporting to said owner of said lost wireless device activity of said lost wireless device since reported lost.

7. The method of recovering a lost wireless device according to claim 6, wherein:
said reporting is performed via e-mail.

8. The method of recovering a lost wireless device according to claim 6, wherein:
said reporting is performed via a web page.

9. The method of recovering a lost wireless device according to claim 1, wherein:
said lost wireless device is a wireless phone.

10. The method of recovering a lost wireless device according to claim 1, further comprising:
prompting an owner of said lost wireless device of a particular one of a plurality of available lost wireless device recovery modes.

11. The method of recovering a lost wireless device according to claim 10, wherein said plurality of available lost wireless device recovery modes comprise:
disabling of long distance from said lost wireless device;
allowing local calls only at designated times;
allowing reception of calls only;
allowing local calls only until prepaid use is exhausted; and
allowing calls with designated phone numbers only.

12. Apparatus for recovering a lost wireless device, comprising:
means for activating a lost wireless device recovery mode relating to use of said lost wireless device; and
means for restricting use of said lost wireless device while said lost wireless device recovery mode is active, said restricted use allowing at least some use of said lost wireless device.

13. The apparatus for recovering a lost wireless device according to claim 12, further comprising:
means for transmitting for display on said lost wireless device information relating that said lost wireless device is in fact lost.

14. The apparatus for recovering a lost wireless device according to claim 12, wherein:
said means for activating activates said lost phone recovery mode at a service provider providing service to said lost wireless device.

15. The apparatus for recovering a lost wireless device according to claim 12, wherein:
said means for activating includes a web-based user interface whereby said user requests activation of said lost wireless device recovery mode.

16. The apparatus for recovering a lost wireless device according to claim 12, wherein:
said means for activating includes a user interface to an owner of said lost wireless device via a phone other than said lost wireless device.

17. The apparatus for recovering a lost wireless device according to claim 12, further comprising:
means for reporting to said owner of said lost wireless device activity of said lost wireless device since reported lost.

18. The apparatus for recovering a lost wireless device according to claim 17, wherein:
said means for reporting reports via e-mail.

19. The apparatus for recovering a lost wireless device according to claim 17, wherein:
said means for reporting reports via a web page.

20. The apparatus for recovering a lost wireless device according to claim 12, wherein:
said lost wireless device is a wireless phone.

21. The apparatus for recovering a lost wireless device according to claim 12, further comprising:
means for prompting an owner of said lost wireless device of a particular one of a plurality of available lost wireless device recovery modes.

22. The apparatus for recovering a lost wireless device according to claim 21, wherein said plurality of available lost wireless device recovery modes comprise:
means for disabling of long distance from said lost wireless device;
means for allowing local calls only at designated times;
means for allowing reception of calls only;
means for allowing local calls only until prepaid use is exhausted; and
means for allowing calls with designated phone numbers only.
